(19) United States
(12) Patent Application Publication
(10) Pub. No.: US 2017/0101177 A1
(43) Pub. Date: Apr. 13, 2017

(54) Chain-Connected Micro-Areal Vehicles

(71) Applicants: Andrei Vladimirovitch Smirnov, VIENNA, VA (US); Michael Andrew Smirnoff, Vienna, VA (US)

(72) Inventors: Andrei Vladimirovitch Smirnov, VIENNA, VA (US); Michael Andrew Smirnoff, Vienna, VA (US)

(21) Appl. No.: 15/313,085

(22) PCT Filed: Jan. 15, 2015
(86) PCT No.: PCT/IB2015/050290

§ 371 Date: Nov. 21, 2016

Related U.S. Application Data
(60) Provisional application No. 62/012,360, filed on Jun. 15, 2014.

(51) Int. Cl. B64C 37/02; B64C 39/02; B64C 33/00

(52) U.S. Cl. CPC B64C 37/02; B64C 33/00; B64C 39/024; B64C 39/028; B64C 2201/025

(57) ABSTRACT

This invention proposes a method which enables one to combine several autonomous areal vehicles into a larger areal vehicle.

In particular, the proposed method enables arranging areal vehicles in a joint formation whereby a number of winged sections is joined horizontally and the flapping of the wings between the sections is coordinated in such a manner as to increase the lift-to-drag ratio. Changing the angle between the sections during the flight is done to increase the maneuverability of the vehicle.

### TECHNICAL FIELD

This invention relates to the field of unmanned flying vehicles in general and micro-areal vehicles in particular.

### BACKGROUND ART

Flight of several micro-areal vehicles (MAV) can be arranged in joined or disjoint manner. Swarms of MAVs often have to fly in a coordinated fashion to achieve mission objectives. Physically coupling or uncoupling of MAVs during the flight can be used to achieve a more economical flight over long distances as well as to increase lift force when transporting heavy loads.

### DISCLOSURE OF INVENTION

### Technical Problem

Micro areal vehicles suffer from two major limitations: (1) low lift force which limits their weight-lifting capabilities and (2) high relative drag forces which make it hard to overcome the wind force.

### Solution to Problem

The above mentioned limitations of micro-areal vehicles can be overcome by arranging them in a joined formation. In particular, in the case of winged areal vehicles a number of winged sections is joined horizontally and the flapping of the wings is coordinated between the sections in a such a manner as to increase the lift-to-drag ratio and maneuverability of the formation.

### Advantageous Effects of Invention

Proposed method of linking autonomous areal vehicles enables them to lift heavier loads than a single vehicle is capable of carrying. The method also reduces cumulative drag on the vehicles thereby extending the duration of the flight.

### BRIEF DESCRIPTION OF DRAWINGS

FIG. 1: Coordinated wing flapping in a joined flight

FIG. 2: Front view of a single section

FIG. 3: Rear view of a single section

FIG. 4: Flexing body in a flight

### MODES FOR CARRYING OUT THE INVENTION

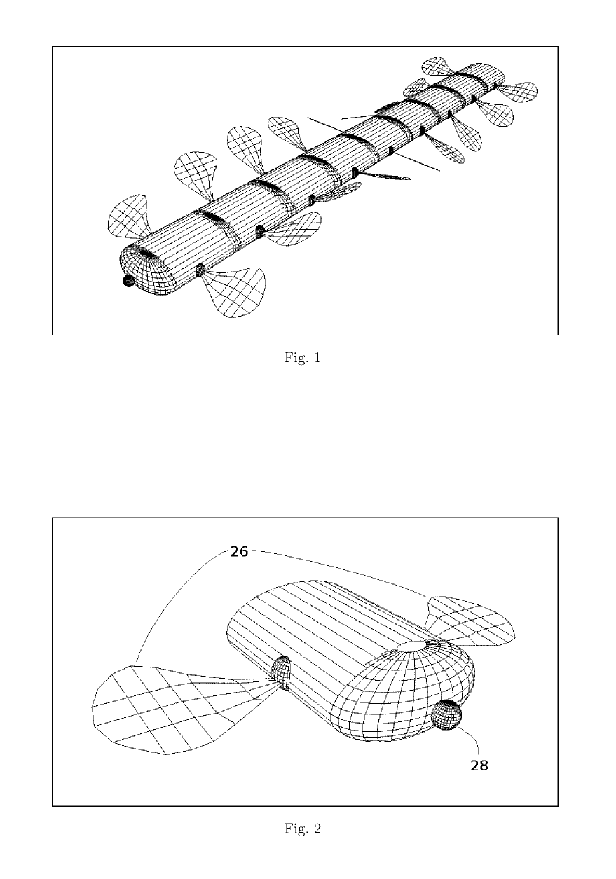

A mode of flying a wing-propelled vehicle described in claim 1 is shown in FIG. 1. In this mode an areal vehicle is equipped with multiple pairs of wings (26) and is capable of coordinated wing flapping so as to produce a coherent wave-like pattern. This type of propulsion is used in nature by sea creatures such as ribbon eels, sear horses, and infusorians. This method of wings flapping in conjunction with a joint flight will increase the total lift to drag ratio, thus enabling longer flight distances and make a vehicle more resistant to wind forces.

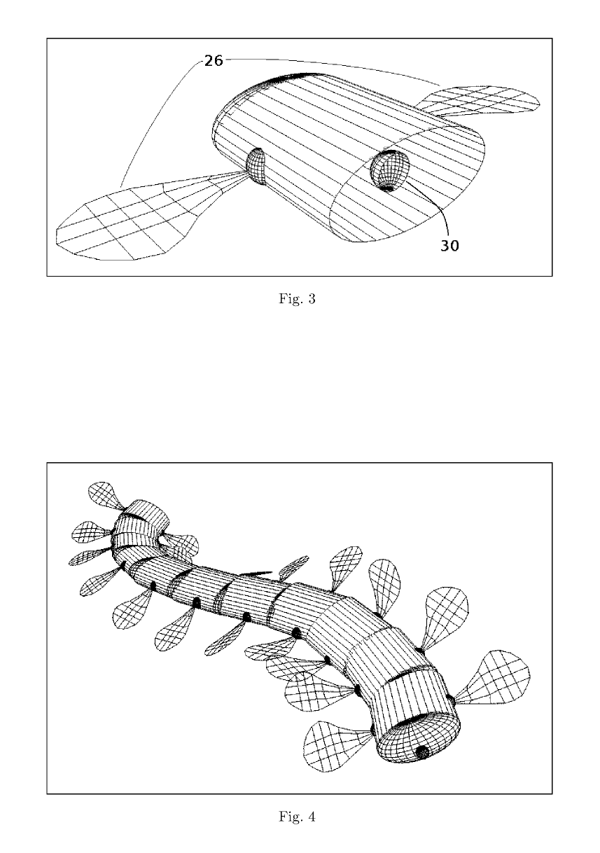

Embodiments of FIGS. 2 and 3 show the method of coupling multiple two-winged sections into a combined multi-winged section. This is done by means of special clams in the front (28) and in the rear (30) of the vehicle. In this joined formation a swarm of micro-areal vehicles flies on a long-distance mission and then uncouples at the destination.

The embodiment of FIG. 4 demonstrates the possibility of flexing the shape of the combined multi-winged vehicle consisting of chain-linked double-winged sections as described in Claim 1. This will provide for a greater maneuverability of the vehicle.

### INDUSTRIAL APPLICABILITY

Micro areal vehicles arranged in the manner suggested by the current invention can be used in such industrial applications as surveillance, retrieval, repair, delivery, toys, and large areas monitoring to name just a few.

### REFERENCE SIGNS LIST

26. Wings
28. Front join mechanism
30. Rear join mechanism

1. An apparatus capable of autonomous flight, consisting of two sections joined one on top of the other and each section comprising:
(a) a vertical rotor shaft of a cylindrical shape with a central hole,
(b) a plurality of rotor blades attached to said rotor shaft,
(c) a vertical central axle extending through the central hole of said rotor shaft above said rotor blades,
(d) top joint clams at the top of said central axle for joining with the other section of the apparatus from the bottom,
(e) a horizontal bottom joint axle at the bottom for joining with said top joint clams of the other section of the apparatus.
(f) an axle tilt mechanism to rotate said bottom joint axle around its axis.

2. A method of enabling autonomous flight capability for a small areal vehicle, comprising:
(a) providing an autonomous areal vehicle equipped with a plurality of wings in a number greater than four,
(b) arranging a coordinated wing flapping whereby tip positions of all wings at each time form a wave-like pattern.

3. The method of claim 2 further comprising:
(a) making the fuselage of said vehicle consisting of separate winged sections, each section having at least one pair of wings and capable of autonomous flight,
(b) providing each said winged section with a front join mechanism, and a rear join mechanism for joining it with the other sections.

4. The method of claim 3 wherein the angle between two joined sections changes during the flight thereby increasing the maneuverability of the areal vehicle.
